(19) United States
(12) Patent Application Publication
(10) Pub. No.: US 2014/0380242 A1
(43) Pub. Date: Dec. 25, 2014

(54) DISPLAYING DATA PROTECTION LEVELS

(71) Applicant: International Business Machines Corporation, Armonk, NY (US)

(72) Inventor: Gregory T. Kishi, Oro Valley, AZ (US)

(21) Appl. No.: 13/925,542

(22) Filed: Jun. 24, 2013

(51) Int. Cl. G06F 3/0481

(52) U.S. Cl. CPC G06F 3/04817
USPC 715/835

(57) ABSTRACT

For displaying data protection levels, a protection module receives a data protection level for a file system object. A display module modifies an icon representing the file system object in a file system graphical user interface to display the data protection level for the file system object.

### BACKGROUND

1. Field

The subject matter disclosed herein relates to data protection levels and more particularly relates to displaying data protection levels.

2. Description of the Related Art

File system objects such as data files and file directories are often protected by backup copies and other types of redundancy. Unfortunately, data protection levels for file system objects are often not readily apparent.

### BRIEF SUMMARY

An apparatus for displaying data protection levels is disclosed. The apparatus includes a protection module and a display module. The protection module receives a data protection level for a file system object. The display module modifies an icon representing the file system object in a file system graphical user interface to display the data protection level for the file system object. A method and computer program product also perform the functions of the apparatus.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic diagram illustrating one embodiment of a hard disk;

FIG. 2 is a schematic block diagram illustrating one embodiment of hierarchical file system;

FIG. 3 is a schematic block diagram illustrating one embodiment of storage devices;

FIGS. 4A-B are drawings illustrating one embodiment of displaying data protection levels in file system graphical user interface;

FIG. 5 is a schematic block diagram illustrating one embodiment of data protection level data;

FIG. 6 is a schematic block diagram illustrating one embodiment of a computer;

FIG. 7 is a schematic block diagram illustrating one embodiment of a display apparatus;

FIG. 8 is a schematic flow chart diagram illustrating one embodiment of a data protection level display method; and

FIGS. 9A-C are drawings illustrating embodiments of modified icons.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

The described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

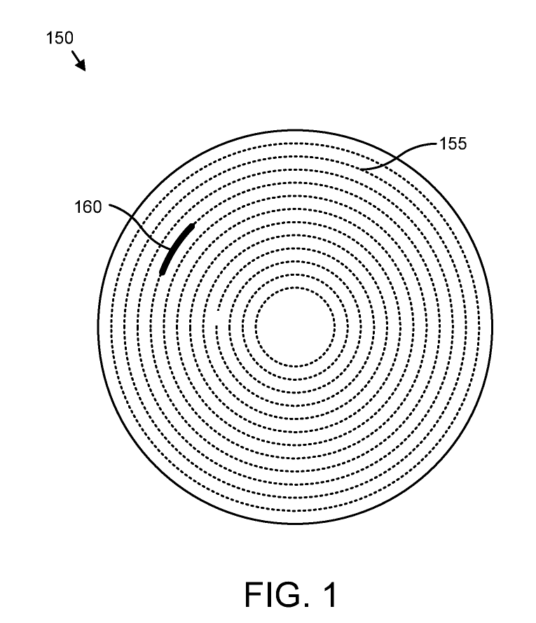

FIG. 1 is a schematic diagram illustrating one embodiment of a hard disk 150. The hard disk 150 stores data as encoded magnetic polarities on a plurality of tracks 155. Each track 155 may include one or more sectors 160. The data on the hard disk 150 may be organized as a file system. The file system may include a plurality of file system objects. File system objects may be directories, files, and the like. Each file system object may include metadata describing the file system object and one or more pointers to data for the file system object stored in sectors 160 of the hard disk 150.

The hard disk 150 is representative of a storage device. One of skill in the art will recognize that embodiments may be practiced with other storage devices such as optical storage devices, micromechanical storage devices, semiconductor storage devices, or combinations thereof.

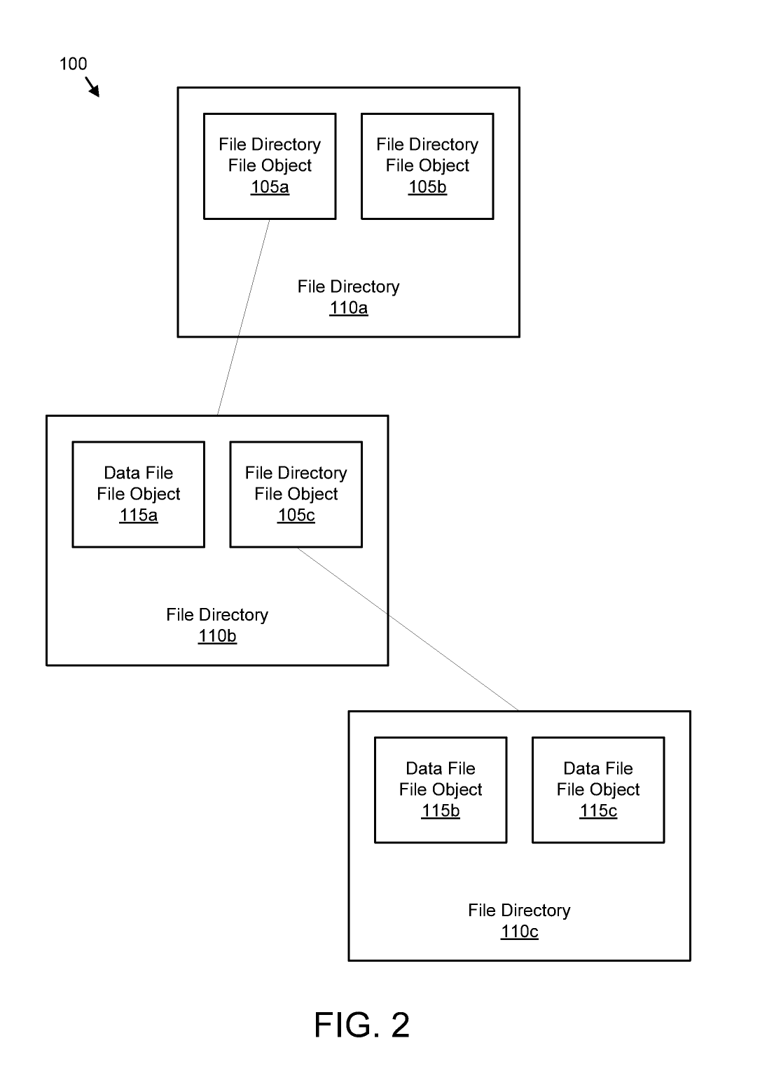

FIG. 2 is a schematic block diagram illustrating one embodiment of a hierarchical file system 100. The file system 100 organizes the data stored on the sectors 160 of the hard disk 150. File system objects 105, 115 such as file directory file objects 105 and data file file objects 115 maybe organized in file directories 110. A file directory file object 105 may reference a file directory 110.

Because a storage device such as the hard disk 150 may fail, data stored in a storage device is often protected. For example, a backup copy may be made of the hard disk 150 or the sectors 160 that contain valid data. Alternatively, the data may be redundantly stored across to multiple storage devices such as a redundant array of independent disks (RAID).

However, no data protection scheme is without some cost, and some data protection schemes are more expensive than others. As a result, different data in the file system 100 may be protected with different data protection schemes. For example, high-value data may be continuously protected with a RAID array so that if there is a failure of a storage device, the high-value data may be quickly recovered and made available. Data of lesser value may be protected with a periodic backup copy so that if there is a failure of the storage device, that data may also be recovered, although not as quickly and with the risk that modifications made after a last backup copy will be lost. Some data, such as temporary files, may not be protected at all.

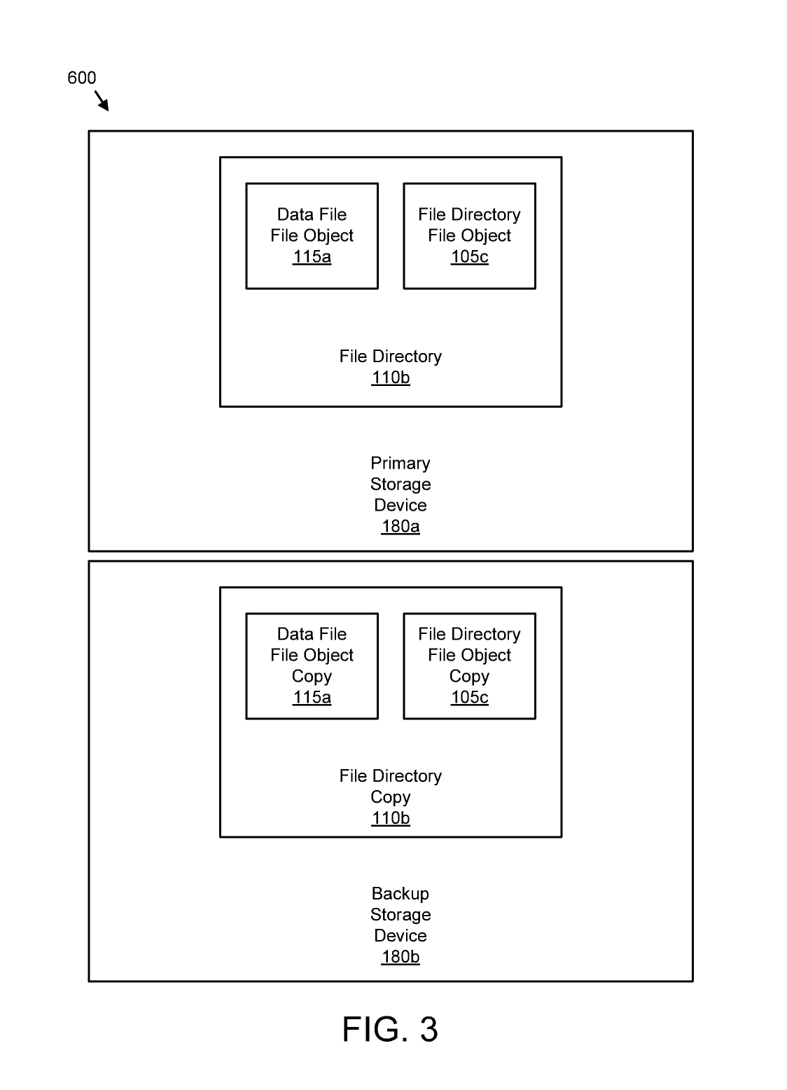

FIG. 3 is a schematic block diagram illustrating one embodiment of storage devices 180. In the depicted embodiment, a primary storage device 180a stores the file directory 110b of FIG. 2. The file directory 110b includes a data file file object 115a and the file directory file object 105c. The data protection level for the file directory 110b may direct that an incremental backup copy of the file directory 110b be created every hour. As a result, modified portions of the file directory 110b may be copied to a backup storage device 180b and stored as a file directory copy 110b.

An administrator may configure the file system 100 so that file system objects are protected with appropriate data level protection. For example, the administrator may configure a file directory 105 storing customer records to be continuously protected on a RAID array while another file directory 105 storing transaction logs is configured for a daily back up.

Unfortunately, the data protection levels for the file system objects of the file system 100 are not readily discernible while navigating a graphical user interface for the file system. Instead, an administrator and/or user must explicitly check the data level protection using a data protection tool and/or by querying the data protection level.

As a result, some high-value data may inadvertently insufficiently protected because a user and/or administrator believe that the high-value data is protected with a higher data protection level than is actually in place. For example, a user may believe that a file directory 110 is protected with a regular backup, when in fact the file directory 110 is unprotected. The user may continue to be unaware that the file directory 110 is insufficiently protected unless the user explicitly checks the data protection level for the file directory 110. The user may fail to check the data protection level if he believes that the file directory 110 is protected.

The embodiments described herein modify an icon representing a file system object in a file system graphical user interface to display the data protection level for the file system object. As a result, the user is apprised of the data protection level for the file system object during normal interactions with the file system object. The user can readily identify file system objects that are inappropriately and/or insufficiently protected and modify the data protection levels to provide more appropriate protection.

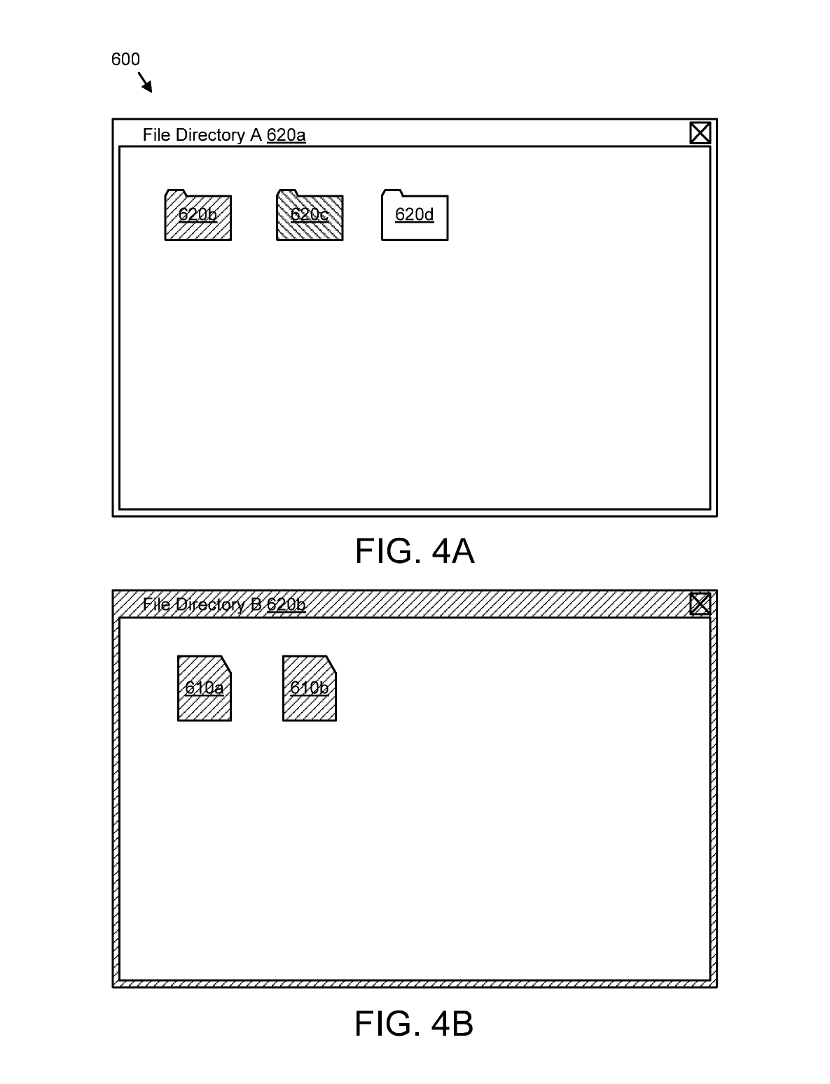

FIGS. 4A-B are drawings illustrating one embodiment of displaying data protection levels in file system graphical user interface 600. FIG. 4A depicts a graphical user interface icon 620a file for file directory A. File directory A may be a file directory 105. The Directory A icon 620a includes three icons 620a-c representing other file directories 105. A second icon 620b represents file directory B and is modified with a first crosshatching to indicate that a first data protection level is employed for file directory B 105. A third icon 620c is modified with a second crosshatching to indicate a second data protection level for another file directory 105. The fourth icon 620d is not modified to indicate that there is no data protection for the file directory 105 associated with the 4th icon 620d. Alternatively, the 4th icon 620d not been modified may indicate that a default data protection level is in place for the file directory 105 associated with the fourth icon 620d.

FIG. 4B depicts a graphical user interface Directory B icon 620b. The file directory B icon 620b is modified with the first crosshatching to indicate that the first data protection level is active for file directory B 105. The file directory B icon 620b also includes a first and second file icon 610a-b representing data file file objects 115.

In one embodiment, a child file system object such as the data file file objects 115 represented by the first and second file icon 610a-b have data protection levels as high as a data protection level for a parent file system object such as the file directory 105 represented by the Directory B icon 620b. Thus if file directory 105 is protected with the first data protection level then each child file system object of file directory 105 is also protected with the first data protection level.

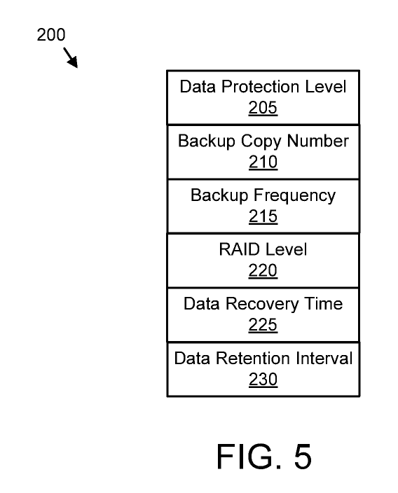

FIG. 5 is a schematic block diagram illustrating one embodiment of data protection level data 200. In one embodiment, the data protection level data 200 is associated with each file system object of the file system 100. The data protection level data 200 may include a data protection level 205, a backup copy number 210, a backup frequency 215, a rate level 220, a data recovery time 225, and a data retention interval 230.

The data protection level 205 may specify a general data protection level for the file system object. For example, the data protection level 205 may specify one of a first data protection level, a second data protection level, and a third data protection level. The first data protection level may specify maintaining at least one backup copy of the file system object. For example, the first data level may specify maintaining two backup copies for the file system object. The first data protection level may further specify a data recovery time 225 greater than a recovery threshold and a data retention interval 230 less than a retention threshold.

The data recovery time 225 may specify a minimum elapsed time for restoring a backup copy and/or redundant copy of the file system object to the file system 100. A user and/or administrator may set the recovery threshold. In one embodiment, the data recovery time 225 for the first data protection level is set to a specified fraction of the recovery threshold. For example, the data recovery time may be one half the recovery threshold.

The data retention interval 230 may specify a length of time that a backup copy of the file system object may be retained. For example, a two-year data retention interval 230 may specify that the backup copy of the file system object is retained for 2 years. The data retention interval 230 may be a multiple of the retention threshold. For example, the data retention interval may be one year and the retention threshold may be three years.

In one embodiment, the second data protection level specifies maintaining one backup copy of the file system object, the data recovery time 225 equal to the recovery threshold, and the data retention interval 230 equal to the retention threshold. For example, the recovery threshold and the data recovery time 225 may be one hour. In addition, the retention threshold in the data retention interval 230 may be one year

The third data protection level may specify maintaining no backup copy of the file system object, the data recovery time 225 greater than the recovery threshold, and the data retention interval 230 less than the retention threshold. For example, if the recovery threshold is one hour, the data recovery time 225 for the third data protection level may be two hours. In addition, if the retention threshold is one year, the data retention interval 230 for the third data protection level may be 6 months.

The backup copy number 210 may specify a number of backup copies for the file system object. For example, the backup copy number 210 may specify three backup copies. In one embodiment, the backup copy number 210 overrides the number of backup copy specified for the data protection level 205.

The backup frequency 215 may specify a time interval between the creation of backup copies, including incremental copies. For example, the backup frequency 215 may specify the creation of backup copies every 1, 6, 12, and/or 24 hours.

The RAID level 220 may specify a type of RAID for protecting the file system object. For example, the RAID level 220 may be RAID 0, RAID 1, RAID 4, RAID 5, or the like.

The data recovery time 225 may specify the minimum data recovery time for the file system object. The recovery time 225 may override the data recovery time of the data protection level 205. Similarly, the data retention interval 230 may specify the data retention interval. The retention interval 230 may override the data retention interval specified for the data protection level 205.

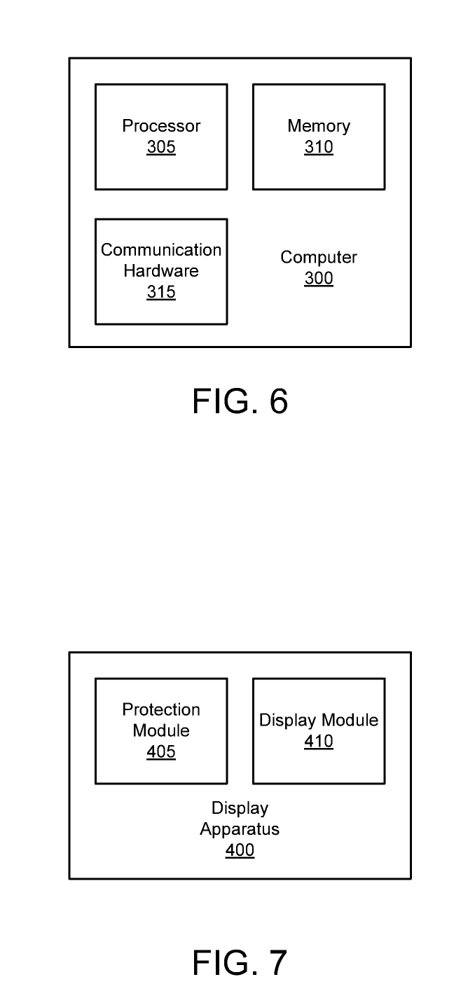

FIG. 6 is a schematic block diagram illustrating one embodiment of a computer 300. The computer 300 may organize the file system 100 on a storage device such as the hard disk 150. The computer 300 includes a processor 305, a memory 310, and communication hardware 315. The memory 310 may be a semiconductor storage device, a hard disk drive employing the hard disk 150, an optical storage device, a micromechanical storage device, or combinations thereof. The memory 310 may store program code. The processor 305 may execute the program code. The communication hardware 315 may communicate with other devices.

FIG. 7 is a schematic block diagram illustrating one embodiment of a display apparatus 400. The apparatus 400 may be embodied in the computer 300 of FIG. 6. The apparatus 400 includes a protection module 405 and a display module 410. The protection module 405 and the display module 410 may comprise one or more of hardware and program code. The program code may be stored on one or more computer readable storage media such as the memory 310.

The protection module 405 may receive a data protection level 205 for a file system object. The display module 410 may modify an icon representing the file system object in the file system graphical user interface 600 to display the data protection level 205 for the file system object.

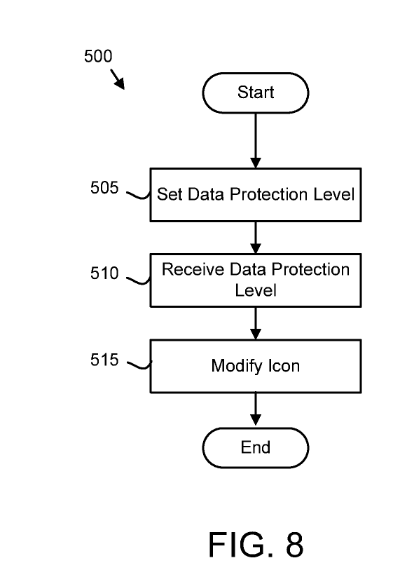

FIG. 8 is a schematic flow chart diagram illustrating one embodiment of a data protection level display method 500. The method 500 may be performed by the apparatus 400. In one embodiment, the method 500 is performed by the processor 305. Alternatively, the method 500 may be performed by a computer program product. The computer program product may comprise a computer readable storage medium such as the memory 310. The computer readable storage medium may have program code embodied thereon. The processor 305 may be readable/executable by the processor 305 to perform the functions of the method 500.

The method 500 starts, and in one embodiment, the protection module 405 sets 505 the data protection level 205 for the file system object. In one embodiment, the protection module 405 sets 505 the data protection level 205 in response to a user command. Alternatively, the protection module 405 sets 505 the data protection level 205 for the file system object so that the data protection level 205 for the file system object is as high as a data protection level 205 for a parent of the file system object.

The protection module 405 may receive 510 the data protection level 205 for the file system object. In one embodiment, the protection module 405 may query metadata for the file system object to determine the data protection level 205. The protection module 405 may query the metadata for the file system object when an icon for the file system object is to be displayed in a graphical user interface for the file system 100. The protection module 405 may cache the data protection levels 205 for recently accessed file system objects.

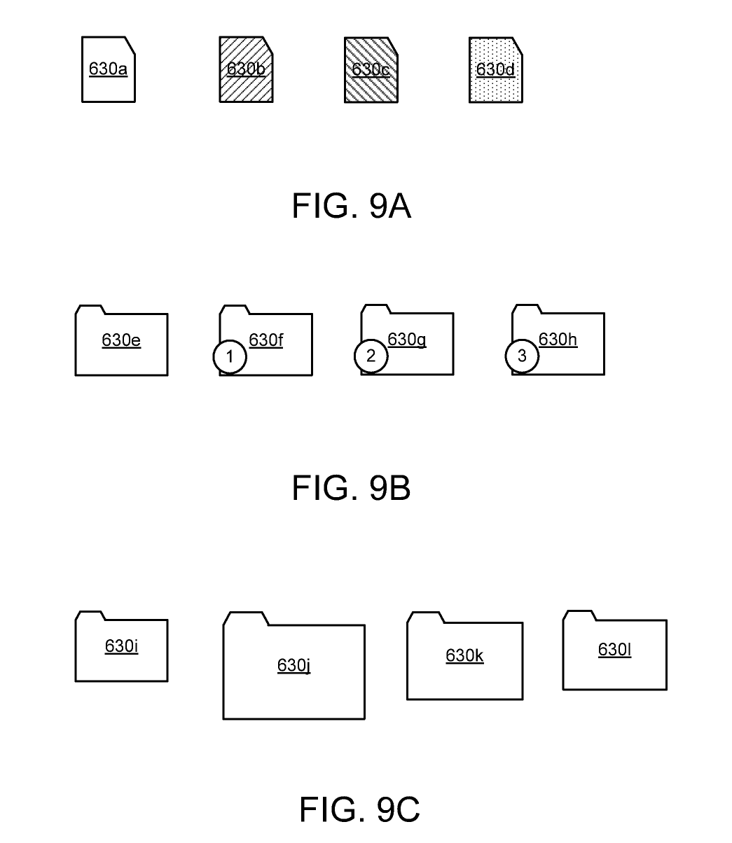

The display module 410 may modify 515 the icon representing the file system object in the file system graphical user interface 600 to display the data protection level 205 for the file system object and the method 500 ends. The icon may be modified 515 with a color indicative of the data protection level. For example, all file system objects with the first data protection level may be represented with red icons, file system objects with the second data protection level may be represented with blue icons, and file system objects with the third data protection level may be represented with white icons. FIG. 9A illustrates using color to indicate data protection levels 205, with crosshatching representing color.

Alternatively, the icon may be modified 515 with an added symbol indicative of the data protection level 205. For example, a number indicating the data protection level 205 may be attended to each icon, with a number 1 indicating the first data protection level as is illustrated in FIG. 9B.

In one embodiment, the icon may be modified 515 with a change in the shape of the icon indicative of the data protection level. For example, files system objects with the first data protection level may be modified 515 with a larger shape while file system objects with the third data protection level may be modified with a smaller shape as is illustrated in FIG. 9C.

FIGS. 9A-C are drawings illustrating embodiments of modified icons 630. In FIG. 9A, a first icon 630a represents an unmodified icon 630 with no crosshatching to indicate a default color. A second icon 630b is crosshatched with the first crosshatching to represent that the second icon 630b is modified with a first color. The first color may represent the first data protection level.

A third icon 630c is crosshatched with the second crosshatching to represent that the third icon 630c is modified with a second color. The second color may represent the second data protection level. In addition, the fourth icon 630d is dimpled to represent that the fourth icon 630d is modified with the third color. The third color may represent the third data protection level.

In FIG. 9B, a fifth icon 630e represents an unmodified icon 630. Sixth, seventh, and eighth icons 630f-h are appended with symbols that indicate the data protection level 205. For example, the sixth icon 630f is appended with a “1” to indicate the first data protection level, the seventh icon 630g is appended with a “2” to indicate the second data protection level, and the eighth icon 630h is appended with a “3” to indicate the third data protection level.

In FIG. 9C, a ninth icon 630i represents an unmodified icon 630. A tenth icon 630j is modified with an enlarged shape to represent the first data protection level. An eleventh icon 630k is modified with a less large shape to represent the second data protection level. A twelfth icon 630l is modified within an even less large shape to represent the third data protection level.

By modifying the icons 630 representing file system objects 105, 115 in the hierarchical file system 100, the embodiments apprise a user of the data protection level 205 for the file system objects 105, 115 during regular interactions with the file system graphical user interface 600. As a result, the user is likely to identify file system objects 105, 115 that are inappropriately and/or insufficiently protected and make corrections.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a protection module receiving a data protection level for a file system object;
a display module modifying an icon representing the file system object in a file system graphical user interface to display the data protection level for the file system object; and
wherein at least a portion of the protection module and the display module comprise one or more of hardware and program code, the program code stored on one or more computer readable storage media.

2. The apparatus of claim 1, the protection module further setting the data protection level for the file system object.

3. The apparatus of claim 1, wherein the icon is modified with at least one of a color indicative of the data protection level, an added symbol indicative of the data protection level, and a change in a shape of the icon indicative of the data protection level.

4. The apparatus of claim 1, wherein the data protection level specifies at least one of a number of backup copies, a backup frequency, a redundant array of independent disks (RAID) level, a minimum recovery time, and a data retention interval.

5. The apparatus of claim 1, wherein the data protection level is one of a first data protection level specifying maintaining at least one backup copy of the file system object, a data recovery time less than a recovery threshold, and a data retention interval greater than a retention threshold, a second data protection level specifying maintaining one backup copy of the file system object, the data recovery time equal to the recovery threshold, and the data retention interval equal to the retention threshold, and a third data protection level specifying maintaining no backup copy of the file system object, the data recovery time greater than the recovery threshold, and the data retention interval less than the retention threshold.

6. A method for displaying data protection levels comprising:
receiving a data protection level for a file system object; and
modifying an icon representing the file system object in a file system graphical user interface to display the data protection level for the file system object.

7. The method of claim 1, further comprising setting the data protection level for the file system object.

8. The method of claim 1, wherein the icon is modified with at least one of a color indicative of the data protection level, an added symbol indicative of the data protection level, and a change in a shape of the icon indicative of the data protection level.

9. The method of claim 1, wherein the data protection level specifies a number of backup copies.

10. The method of claim 1, wherein the data protection level specifies a backup frequency.

11. The method of claim 1, wherein the data protection level specifies a redundant array of independent disks (RAID) level.

12. The method of claim 1, wherein the data protection level specifies a minimum recovery time.

13. The method of claim 1, wherein the data protection level specifies a data retention interval.

14. The method of claim 1, wherein the data protection level is one of a first data protection level specifying maintaining at least one backup copy of the file system object, a data recovery time less than a recovery threshold, and a data retention interval greater than a retention threshold, a second data protection level specifying maintaining one backup copy of the file system object, the data recovery time equal to the recovery threshold, and the data retention interval equal to the retention threshold, and a third data protection level specifying maintaining no backup copy of the file system object, the data recovery time greater than the recovery threshold, and the data retention interval less than the retention threshold.

15. The method of claim 1, wherein the file system object is in a hierarchical file system and a child file system object has a data protection level as high as a data protection level for a parent file system object.

16. A computer program product for displaying data protection levels, the computer program product comprising a computer readable storage medium having program code embodied therein, the program code readable/executable by a processor to:
receive a data protection level for a file system object; and
modify an icon representing the file system object in a file system graphical user interface to display the data protection level for the file system object.

17. The computer program product of claim 16, the program code further setting the data protection level for the file system object.

18. The computer program product of claim 16, wherein the icon is modified with at least one of a color indicative of the data protection level, an added symbol indicative of the data protection level, and a change in a shape of the icon indicative of the data protection level.

19. The computer program product of claim 16, wherein the data protection level specifies at least one of a number of backup copies, a backup frequency, a redundant array of independent disks (RAID) level, and a minimum recovery time, a data retention interval.

20. The computer program product of claim 16, wherein the data protection level is one of a first data protection level specifying maintaining at least one backup copy of the file system object, a data recovery time less than a recovery threshold, and a data retention interval greater than a retention threshold, a second data protection level specifying maintaining one backup copy of the file system object, the data recovery time equal to the recovery threshold, and the data retention interval equal to the retention threshold, and a third data protection level specifying maintaining no backup copy of the file system object, the data recovery time greater than the recovery threshold, and the data retention interval less than the retention threshold.
